(19) United States
(12) Patent Application Publication
(10) Pub. No.: US 2012/0062192 A1
(43) Pub. Date: Mar. 15, 2012

(54) Voltage Regulator

(75) Inventor: Yasuyuki OKUMA, Hachioji (JP)

(73) Assignee: Hitachi, Ltd., Tokyo (JP)

(21) Appl. No.: 13/208,508

(22) Filed: Aug. 12, 2011

(30) Foreign Application Priority Data
Sep. 14, 2010 (JP) JP2010-205155

(51) Int. Cl. G05F 1/00

(52) U.S. Cl. 323/272

(57) ABSTRACT

To provide a voltage regulator capable of stably obtaining a desired output voltage even in a low-voltage operation with a voltage equal to or lower than 1 V, the voltage regulator includes a switch array in which a plurality of switches are connected in parallel, a switch state register storing an ON or OFF state of each of the switches in the switch array, and a comparator comparing a reference voltage and a voltage of an output terminal coupled to an output of the switch array and outputting a comparison result as a digital value, and a state of each of the switches in the switch array is changed by updating a value of the switch state register in accordance with the output of the digital value from the comparator.

### CROSS-REFERENCE TO RELATED APPLICATION

The present application claims priority from Japanese Patent Application No. 2010-205155 filed on Sep. 14, 2010, the content of which is hereby incorporated by reference into this application.

### TECHNICAL FIELD OF THE INVENTION

The invention relates to a voltage regular technology. More particularly, the present invention relates to a technology effectively applied to a voltage regulator converting an input voltage to a desired output voltage based on a reference voltage.

### BACKGROUND OF THE INVENTION

In recent years, applications using a power generating element represented by a solar battery as a power supply have been actively studied. Also, along with the advance of microfabrication, the operation voltage of a semiconductor circuit has been decreased. In a digital circuit, an operation with a voltage equal to or lower than 1.0 V is possible. According to this background, in the use of a solar battery, an application using a single-cell solar battery with less influence of partial shadow has attracted attention. In general, in a single-cell solar battery, an electromotive force has a low voltage of 0.6 V to 1.0 V. When a single-cell solar battery is assumed to be used, its voltage regulator is required to operate with a voltage equal to or lower than 1.0 V.

As an example of a conventional technology, a circuit illustrated in FIG. 3 of U.S. Pat. No. 7,372,382 B2 (Patent Document 1) is known. In the technology disclosed in Patent Document 1, the circuit is configured of: an amplifier amplifying a difference between a reference voltage and a feedback voltage fed back from an output voltage to output an analog signal; a resistor connected in series and dividing the voltage between the analog signal outputted from this amplifier and a predetermined voltage supplied; a plurality of inverters receiving inputs of voltages each obtained by voltage division; and a plurality of transistors to which an output and a gate of each inverter are connected. In this structure, the output voltage is fed back, an analog signal is generated by amplifying a difference between the output voltage and the reference voltage, and each analog voltage is generated by dividing the voltage between the analog signal and the predetermined voltage. Then, in each of the inverters coupled to the respective analog voltages, depending on whether the analog voltage is larger or smaller than a threshold of the inverter, a High or Low output is determined. Eventually, the number of turn-on or turn-off transistors is changed in accordance with the analog signal, thereby obtaining a desired output voltage.

### SUMMARY OF THE INVENTION

However, in the technology of Patent Document mentioned above, an amplifier outputting an analog signal is used to control the transistors. Therefore, for example, in a low-voltage operation with a voltage equal to or lower than 1 V, it is difficult to achieve an analog amplifier having a gain and band to achieve sufficient feed-back control and, as a result, it is also disadvantageously difficult to achieve a voltage regulator achieving a desired output voltage.

Moreover, in the technology of Patent Document 1 mentioned above, with a low voltage, a difference between the analog signal as an output from the amplifier and the predetermined supplied voltage is also small, and a difference between the analog voltage obtained by division and the threshold of the inverter is also small. For this reason, an influence of noise is relatively large, causing the operation of the inverters to be unstable and significantly exerting the influence of noise also on the state of inverter outputs. This also causes an unstable state and number of switches, which are controlled by the operation output of the inverters to be turned on or off. As a result, the output voltage also disadvantageously becomes unstable.

The present invention solves the problems described above, and a typical preferred aim of the present invention is to provide a voltage regulator capable of stably obtaining a desired output voltage even in a low-voltage operation at a voltage equal to or lower than 1 V.

The above and other preferred aims and novel characteristics of the present invention will be apparent from the description of the present specification and the accompanying drawings.

The typical ones of the inventions disclosed in the present application will be briefly described as follows.

That is, a general outline of the typical elements is to provide voltage regulator being provided and using a digital circuit and a digital signal operable even with a low voltage without using the analog amplifier as described above or an analog signal output from the analog amplifier.

A voltage regulator including: a switch array in which a plurality of switches are connected in parallel; a switch state register storing an ON or OFF state of each of the switches in the switch array; and a comparator comparing a reference voltage and a voltage of an output terminal coupled to an output of the switch array and outputting a result of the comparison as a digital value, wherein a state of each of the switches in the switch array is changed by updating a value of the switch state register in accordance with an output of the digital value from the comparator.

A voltage regulator including: a switch array in which a plurality of switches are connected in parallel; a switch state register storing an ON or OFF state of each of the switches in the switch array; and an inverter having a logical threshold corresponding to a desired output voltage, comparing the logical threshold with a voltage of an output terminal connected to an output of the switch array, and outputting a result of the comparison as a digital value, wherein a state of each of the switches in the switch array is changed by updating a value of the switch state register in accordance with an output of the digital value from the inverter.

A voltage regulator including: a switch array in which a plurality of switches are connected in parallel; a switch state register storing an ON or OFF state of each of the switches in the switch array; a change value register storing a value to be added or subtracted at the time of updating the switch state register; and a plurality of comparators comparing reference voltages having different voltages and a voltage of an output terminal connected to an output of the switch array and outputting each result of the comparison as a digital value, wherein a state of each of the switches in the switch array is changed by updating a value of the change value register in accordance with an output of a digital value from a first comparator among the plurality of comparators and updating a value of the switch state register in accordance with an output of a digital value from a second comparator that is different from the first comparator.

The effects obtained by typical aspects of the present invention will be briefly described below.

That is, an effect that can be achieved by the typical invention is to provide a voltage regulator capable of stably obtaining a desirable output voltage even in a low voltage operation equal to or lower than 1 V.

### BRIEF DESCRIPTIONS OF THE DRAWINGS

FIG. 1 is a diagram of a configuration example of a voltage regulator according to a first embodiment of the present invention;

FIG. 2 is a diagram of an example of an update flow of a switch state register in the voltage regulator according to the first embodiment of the present invention;

FIG. 3 is a diagram of a first configuration example of a switch in the voltage regulator according to the first embodiment of the present invention;

FIG. 4 is a diagram of a configuration example of a voltage regulator according to a second embodiment of the present invention;

FIG. 5 is a diagram of a configuration example of a voltage regulator according to a third embodiment of the present invention;

FIG. 6 is a diagram of a configuration example of a voltage regulator according to a fourth embodiment of the present invention;

FIG. 7 is a diagram of an example of states and state transitions of a shift register in the voltage regulator according to the fourth embodiment of the present invention;

FIG. 8 is a diagram of an example of changes of the number of turn-on PMOS transistors in a switch array in the voltage regulator according to the fourth embodiment of the present invention;

FIG. 9 is a diagram of an example of changes of an output voltage outputted to an output terminal with respect to a reference voltage applied to a reference voltage terminal in the voltage regulator according to the fourth embodiment of the present invention;

FIG. 10 is a diagram of a configuration example of a semiconductor IC having a voltage regulator according to any of the first to fourth embodiments mounted thereon in a fifth embodiment of the present invention;

FIG. 11 is a diagram of an example of a relation between a resistance on the entire switch array and the number of turn-on switches in a voltage regulator according to a sixth embodiment of the present invention;

FIG. 12 is a diagram of an example of a relation between a resistance on the entire switch array and the number of turn-on switches using weighted switches in a voltage regulator according to the sixth embodiment of the present invention;

FIG. 13 is a diagram of a second configuration example of a switch for use in a switch array in a voltage regulator according to a seventh embodiment of the present invention;

FIG. 14 is a diagram of a third configuration example of a switch for use in a switch array in a voltage regulator according to an eighth embodiment of the present invention; and

FIG. 15 is a diagram of a fourth configuration example of a switch for use in a switch array in a voltage regulator according to a ninth embodiment of the present invention.

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable.

Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### First Embodiment

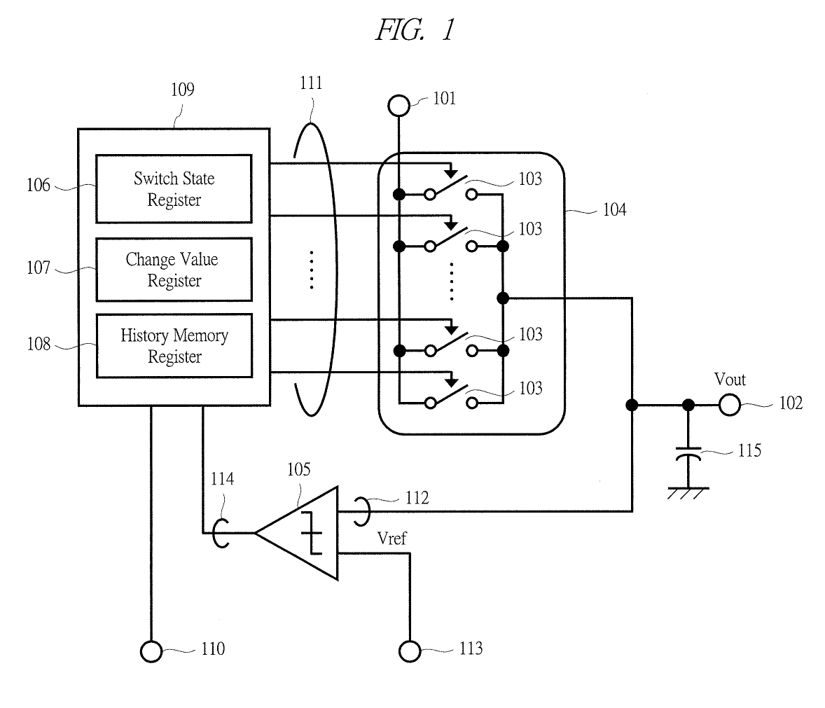

A voltage regulator according to a first embodiment of the present invention will be described with reference to FIGS. 1 to 3.

The voltage regulator according to the present embodiment includes, at least, a switch array (104) in which a plurality of switches (103) are connected in parallel, a switch state register (106) storing an ON or OFF state of each of the switches in the switch array, and a comparator (105) comparing a reference voltage and a voltage of an output terminal coupled to an output of the switch array and outputting a comparison result as a digital value. A state of each of the switches in the switch array is changed by updating a value of the switch state register with the output of the digital value from the comparator.

More preferably, the voltage regulator further includes a change value register (107) storing an amount of a change of a value to be updated in the switch state register and a history storage register (108) storing a change history of the switch state register. A value of the change value register is updated with a state of the change history in the history storage register and, according to the output of the digital value from the comparator, only the value of the switch state register is increased or decreased by the value of the change value register.

The voltage register according to the present embodiment having the features as described above is now described in detail below with reference to the drawings.

First, the configuration of the voltage register according to the first embodiment of the present invention is described with reference to FIG. 1. FIG. 1 is a diagram of a configuration example of the voltage regulator.

The voltage regulator of the present embodiment includes an input terminal 101; an output terminal 102; a reference voltage terminal 113 and a clock terminal 110; a switch array 104 including a plurality of switches 103; a comparator 105; a controller 109 including a switch state register 106, a change value register 107, and a history storage register 108; a smoothing capacitor 115; and others.

To the input terminal 101, an input voltage is inputted. From the output terminal 102, an output voltage is outputted. To the reference voltage terminal 113, a reference voltage is inputted. To the clock terminal 110, a clock signal defining the operation of the controller 109 is inputted.

The switch array 104 is connected to the input terminal 101, the output terminal 102, and the controller 109, and is configured of the plurality of switches 103. Each of the switches 103 has one end connected to the input terminal 101 and the other end connected to the output terminal 102, and is controlled by a switch control signal 111, which is an output from the controller 109. As such, the switch array 104 is configured with the plurality of switches 103 connecting the input terminal 101 and the output terminal 102 together being connected in parallel. As each of the switches 103 of the switch array 104, for example, a MOS transistor, a bipolar transistor, or the like is used.

The comparator 105 has an input side connected to the output terminal 102 and the reference voltage terminal 113 and an output side connected to the controller 109. With a feedback voltage 112 generated from an output voltage Vout occurring at the output terminal 102 and a reference voltage Vref inputted to the reference voltage terminal 113 as inputs, the comparator 105 compares the feedback voltage 112 and the reference voltage Vref, and outputs a comparison result as a comparison result signal 114 of a digital value.

The switch state register 106 is a register storing an ON or OFF state of each switch 103 of the switch array 104. The change value register 107 is a register retaining a value for increasing or decreasing the number of turn-on or turn-off switches 103 when the switch state register 106 is updated. The history storage register 108 is a register storing at least one or more change histories each as a previous change history of the switch state register 106.

The controller 109 is connected to the clock terminal 110, the comparator 105, and the switch array 104, and includes the switch state register 106, the change value register 107, and the history storage register 108. With the comparison result signal 114 as an output from the comparator 105 as an input, the controller 109 is configured to output a switch control signal 111 of a digital value for controlling each switch 103 of the switch array 104.

The smoothing capacitor 115 is a capacitor having one end connected to the output terminal 102 and the other end connected to GND and smoothing the output voltage Vout outputted from the output terminal 102.

The voltage regulator of the present embodiment structured as described above can be configured of a digital circuit because, in particular, signals from the comparison result signal 114 outputted from the comparator 105 to the switch control signal 111 for controlling each switch 103 of the switch array 104 are digital signals only. Therefore, the structure can be easily designed in a low-voltage operation, and is excellent in anti-noise characteristics.

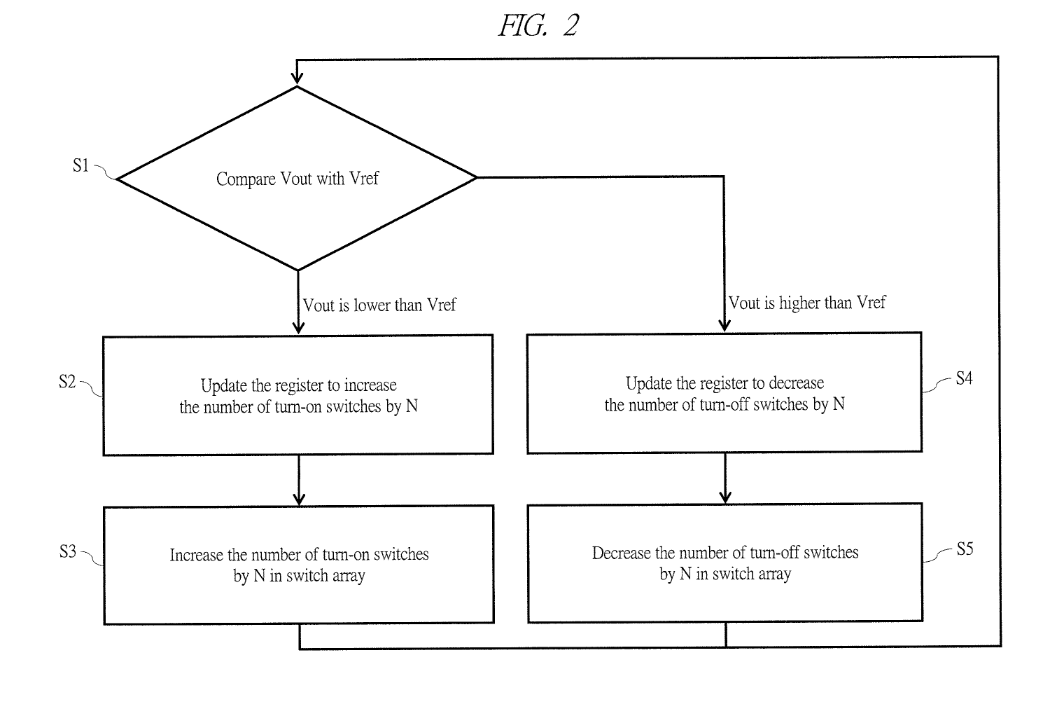

Next, an update flow of the switch state register 106 is described with reference to FIG. 2. FIG. 2 is a diagram of an example of an update flow of the switch state register 106.

First, the output voltage Vout of the output terminal 102 is inputted to the comparator 105 together with the reference voltage Vref for comparison by the comparator 105 (S1). As a result of this comparison, when the output voltage Vout is lower than the reference voltage Vref (or Vout is equal to or lower than Vref), the comparator 105 outputs an L level signal to the controller 109 as the comparison result signal 114. Conversely, when the output voltage Vout is higher than the reference voltage Vref, the comparator 105 outputs an H level signal to the controller 109 as the comparison result signal 114.

In response, when the comparison result signal 114 is an L level signal, the controller 109 updates, for each clock signal, the switch state register 106 so that the number of turn-on switches 103 of the switch array 104 is increased by a value N retained in the change value register 107, and outputs the switch control signal 111 according to the switch state register 106 to the switch array 104 (S2). Then, in the switch array 104, each switch 103 is controlled with the switch control signal 111, and the number of turn-on switches 103 is increased by N (S3).

On the other hand, when the comparison result signal 114 is an H level signal, the controller 109 updates, for each clock signal, the switch state register 106 so that the number of turn-on switches 103 of the switch array 104 is decreased by the value N retained in the change value register 107, and outputs the switch control signal 111 according to the switch state register 106 to the switch array 104 (S4). Then, in the switch array 104, each switch 103 is controlled with the switch control signal 111, and the number of turn-on switches 103 is decreased by N (S5).

As such, with feedback control in which the number of turn-on switches 103 and the number of turn-off switches 103 of the switch array 104 are changed, the output voltage Vout of the output terminal 102 can be controlled to a desired voltage according to the reference voltage Vref.

The procedure of FIG. 2 shows an operation of increasing or decreasing the value retained in the switch state register 106 by the value of the change value register 107 in response to the comparison result signal 114 with a digital value outputted from the comparator 105. The operation of repeatedly increasing or decreasing the value of the switch state register 106 is equivalent to an integrating operation. The integrating operation achieves a function of equalizing the output voltage with the reference voltage because a DC (direct current) gain in feedback control is infinite.

The history storage register 108 records a change history of the switch state register 106. For example, when there is a difference between the output voltage Vout and the reference voltage Vref and the switch state register 106 is increased or decreased continuously for a predetermined number of iterations with a number N of changes for increase or decrease, the value of the change value register 107 is changed from N to a larger value M. In this manner, a change in the number of turn-on or turn-off switches 103 is advantageously increased to change the output voltage quickly. Also, when an increase or decrease is reversed, the change value register 107 is initialized, thereby allowing initial characteristics to be achieved. On the other hand, when the difference between the output voltage Vout and the reference voltage Vref is small and the switch state register 106 is alternately increased and decreased every time with a number N of changes for increase or decrease, the value of the change value register 107 is changed from N to a smaller value L. In this manner, a change in the number of turn-on or turn-off switches 103 is advantageously decreased to decrease fluctuations in output voltage for further stabilization.

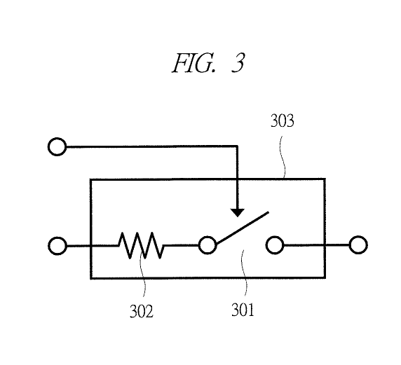

Each of the switches 103 configuring the switch array 104 is practically a switch having an ON-resistance value r1. Alternatively, when the ON-resistance value r1 is extremely small, a switch structure as illustrated in FIG. 3 can be considered. FIG. 3 is a diagram of a first configuration example of the switch 103. As illustrated in FIG. 3, the first configuration example of the switch 103 is configured of a switch circuit 303 in which a resistor 302 having a resister value r2 is connected to the switch 301 in series with a circuit resistance value r3=r1+r2. Therefore, changing the number of turn-on switches 103 in the switch array 104 means changing a resistance value Rsa of the switch array 104. A relation with the ON resistance r1 of each switch 103 or the circuit resistance value r3 of the switch circuit 303 is represented by Equation (1) when the number of turn-on switches 103 is N:

Rsa=r1/N=r3/N (1).

A load is connected to the output terminal 102 of the voltage regulator. When a load current at this time is IL, the voltage of the input terminal 101 is Vin, and the voltage of the output terminal 102 is Vout, the output voltage Vout is represented by Equation (2):

Vout=Vin−IL×Rsa (2).

When a resistance value of the load is RL, the voltage Vout of the output terminal 102 is represented by Equation (3):

Vout=RL/(Rsa+RL)×Vin (3).

According to the voltage regulator of the present embodiment described above, the comparator 105 compares the reference voltage and the feedback voltage 112 to output the comparison result signal 114 with a digital value. Furthermore, according to two signals, that is, the clock signal and the comparison result signal 114, the controller 109 updates the value of the switch state register 106. Then, the controller 109 outputs the switch control signal 111 with a digital value according to the switch state register 106 to change the number of turn-on or turn-off switches 103 in the switch array 104, thereby controlling so that the output voltage becomes a desired voltage.

In this manner, a signal propagating from the output of the comparator 105 to the input to the switch array 104 in the feedback circuit is a signal with a digital value, and this feedback circuit can be achieved by a digital circuit only. As a result, the voltage regulator can be configured without using an analog circuit, which outputs an analog signal, with which a low-voltage operation is difficult. Thus, as signal propagation being achieved only with a digital signal excellent in anti-noise characteristics, an influence of noise can be reduced, and a stable operation in a low-voltage operation can be improved. Therefore, according to the present embodiment, a voltage regulator having an easy circuit design even in a low-voltage operation and capable of a stable operation can be provided.

### Second Embodiment

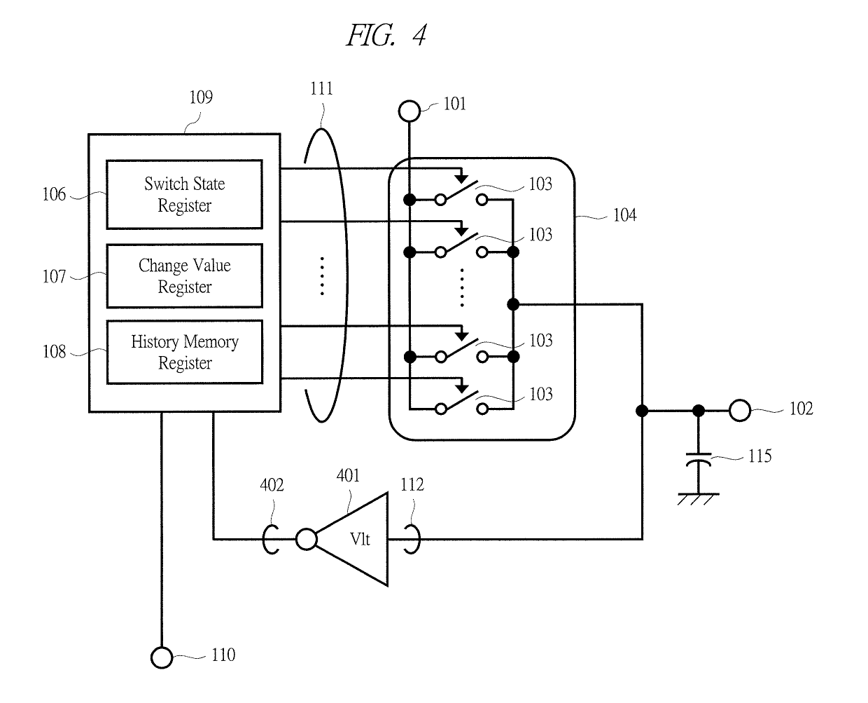

A voltage regulator according to a second embodiment of the present invention will be described with reference to FIG. 4.

The voltage regulator according to the present embodiment includes, at least, a switch array (104) in which a plurality of switches (103) are connected in parallel, a switch state register (106) storing an ON or OFF state of each of the switches in the switch array, and an inverter (401) having a logical threshold corresponding to a desired output voltage, comparing the logical threshold with a voltage of an output terminal coupled to an output of the switch array, and outputting the comparison result as a digital value. A state of each of the switches in the switch array is changed by updating a value of the switch state register in accordance with the output of the digital value from the inverter.

More preferably, the voltage regulator further includes a change value register (107) storing an amount of change of a value to be updated in the switch state register and a history storage register (108) storing a change history of the switch state register. A value of the change value register is updated with a state of the change history in the switch state register and, according to the output of the digital value from the inverter, the switch state register is increased or decreased by the value of the change value register.

The voltage regulator according to the present embodiment having the features as described above is now described in detail below with reference to the drawings. Portions different from those of the first embodiment described above are mainly described, and descriptions of the same portions are omitted herein.

FIG. 4 is a diagram of a configuration example of a voltage regulator according to a second embodiment of the present invention.

As compared with the voltage regulator of the first embodiment, the voltage regulator of the present embodiment is configured with the comparator 105 replaced by the inverter 401 having a desired logical threshold Vlt. According to the replacement of the comparator 105 by the inverter 401 having the logical threshold Vlt, the need for the reference voltage terminal 113 is eliminated, and the logical threshold Vlt functions as a reference voltage in place of the reference voltage Vref. This is because an output signal 402 is at an L level when the feedback voltage 112 is inputted to the inverter 401 and the feedback voltage 112 is above the logical threshold Vlt and, conversely, the output signal 402 is at an H level when the feedback voltage 112 is below the logical threshold Vlt.

In this manner, a voltage regulator without the need for an input of a reference voltage from outside can be achieved. However, in the present embodiment, the controller 109 performs an operation of subtracting the value of the change value register 107 from the value of the switch state register 106 when a signal at an L level is inputted and adding the value of the change value register 107 to the value of the switch state register 106 when a signal at an H level is inputted. In this manner, the operation of the controller 109 is determined by design and settings of the feedback signal so that feedback control functions normally. Note that, in the structure as described in the present embodiment, in place of the inverter 401 having the logical threshold Vlt, an inverter capable of controlling the logical threshold with an external signal can be used to make the output voltage variable.

According to the voltage regulator of the present embodiment described above, in addition to effects similar to those of the first embodiment, the need for inputting a reference voltage from outside can be eliminated.

### Third Embodiment

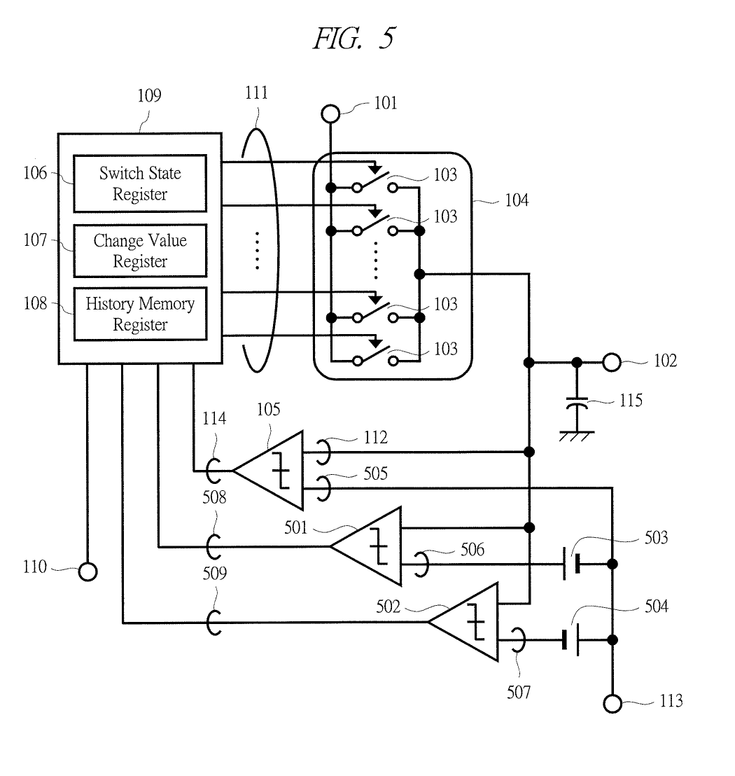

A voltage regulator according to a third embodiment of the present invention is described with reference to FIG. 5.

The voltage regulator according to the present embodiment includes a switch array (104) in which a plurality of switches (103) are connected in parallel, a switch state register (106) storing an ON or OFF state of each of the switches in the switch array, a change value register (107) storing a value to be added or subtracted at the time of the updating the switch state register, and a plurality of comparators (105, 501, 502) comparing reference voltages having different voltages and a voltage of an output terminal coupled to an output of the switch array and outputting each comparison result as a digital value. A state of each of the switches in the switch array is changed by updating a value of the change value register according to the output of the digital value from a first comparator (501, 502) among the plurality of comparators and updating a value of the switch state register with the output of the digital value from a second comparator (105) different from the first comparator.

More preferably, the voltage regulator further includes a history storage register (108) storing a change history of the switch state register. A value of the change value register is updated with a state of the change history in the history storage register and, according to the output of the digital value from the second comparator, the switch state register is increased or decreased by the value of the change value register.

The voltage regulator according to the present embodiment having the features as described above is described in detail below with reference to the drawings. Portions different from those of the first embodiment described above are mainly described, and descriptions of the same portions are omitted herein.

FIG. 5 is a diagram of a configuration example of the voltage regulator according to the third embodiment of the present invention.

As compared with the voltage regulator of the first embodiment, the voltage regulator of the present embodiment is configured to further include comparators 501 and 502 and offset voltage sources 503 and 504. To the comparator 501, a voltage Vref+Voff1 obtained by adding a voltage Voff1 of the offset voltage source 503 to a reference voltage Vref 505 inputted to the comparator 105 is inputted as a reference signal 506 and is compared with the feedback voltage 112, and the comparator 501 then outputs a comparison result signal 508. Similarly, to the comparator 502, a voltage Vref−Voff2 obtained by subtracting a voltage Voff2 of the offset voltage source 504 from the reference voltage Vref 505 is inputted as a reference signal 507 and is compared with the feedback voltage 112, and the comparator 502 then outputs a comparison result signal 509.

In these two comparators 501 and 502, whether the feedback voltage 112 is within Vref+Voff1 and Vref−Voff2 can be determined with the comparison result signals 508 and 509. In this manner, by using the information about the comparison result signals 508 and 509, the controller 109 can change the value of the change value register 107 to an appropriate value when a difference between the output voltage and the reference voltage is equal to or larger than a predetermined value. As a result, the convergence property of the output voltage can be improved. Alternatively, stability of the output voltage can be improved. Note that, in the structure as in the present embodiment, reference voltages may be directly inputted for the reference signals 506 and 507.

According to the voltage regulator of the present embodiment described above, in addition to the effects similar to those of the first embodiment, the convergence property or stability of the output voltage can be improved when a difference between the output voltage and the reference voltage is equal to or larger than a predetermined value.

### Fourth Embodiment

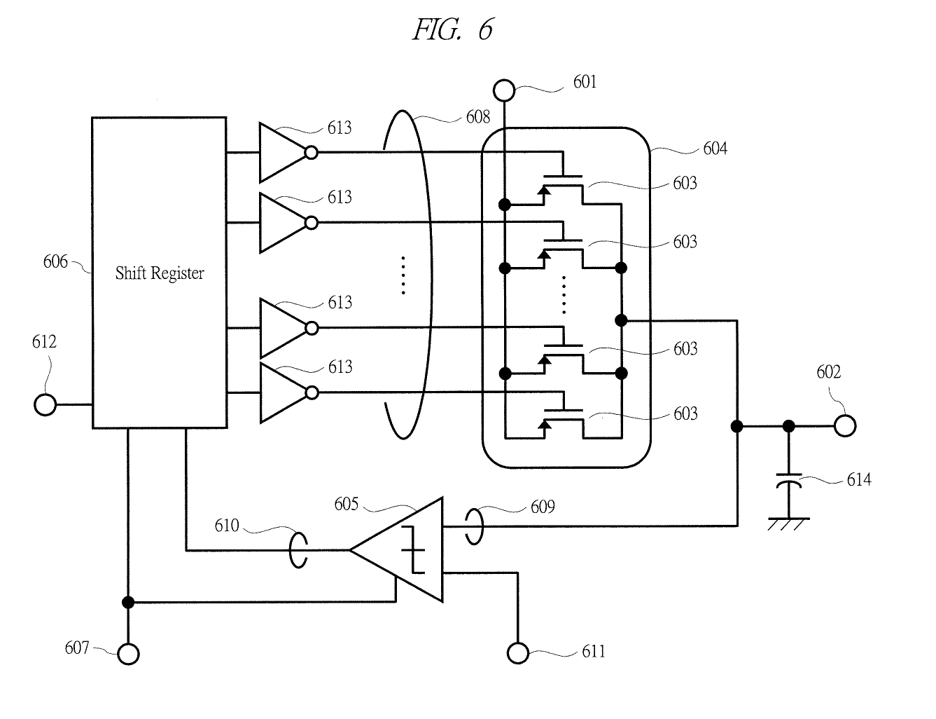

A voltage regulator according to a fourth embodiment of the present invention is described with reference to FIGS. 6 to 9.

The voltage regulator according to the present embodiment has a configuration for specifically achieving the voltage regulator according to the first embodiment described above and, as the switch state register, a shift register (606) shifting the value of the register according to the output from the comparator for each clock is used. Here, although not restrictive, a shift register of a 256-bit length is taken as an example for description. Note that the same goes for the case in which the register is applied to the voltage regulator according to any of the second and third embodiments.

First, the structure of the voltage regulator according to the fourth embodiment of the present invention is described with reference to FIG. 6. FIG. 6 is a diagram of a configuration example of the voltage regulator.

As compared with the voltage regulator of the first embodiment, the voltage regulator of the present embodiment is configured, specifically, so that the switches in the switch array are achieved by PMOS transistors and the switch state register in the controller is achieved by a shift register and an inverter.

That is, the voltage regulator of the present embodiment is configured of an input terminal 601, an output terminal 602, a reference voltage terminal 611, a clock terminal 607 and a reset terminal 612, a switch array 604 including a plurality of PMOS transistors 603, a comparator 605, a shift register 606, an inverter 613, a smoothing capacitor 614, and others.

The functions of the input terminal 601, the output terminal 602, the reference voltage terminal 611, and the clock terminal 607 are similar to those of the first embodiment. The reset terminal 612 is a terminal for resetting the shift register 606.

The switch array 604 is configured of 256 PMOS transistors 603 connected in parallel, each PMOS transistor having a source terminal connected to the input terminal 601 and a drain terminal connected to the output terminal 602, and is controlled with a switch control signal 608 as an output from the inverter 613.

The comparator 605 is a circuit that compares a feedback voltage 609 fed back from the output terminal 602 and a reference voltage inputted from the reference voltage terminal 611 and outputs the comparison result as a comparison result signal 610 with a digital value. As the comparator 605, a clocked comparator operating in synchronization with a clock inputted to the clock terminal 607 is used.

The shift register 606 is configured to have a 256-bit length, and shifts to the right or left by one bit for each clock inputted from the clock terminal 607 in accordance with the comparison result signal 610 inputted from the comparator 605.

The inverter 613 couples an output of each bit of the shift register 606 to the gate of each of the PMOS transistors 603 in the switch array 604 and can drive the gate of each of the PMOS transistors 603 in accordance with the switch control signal 608.

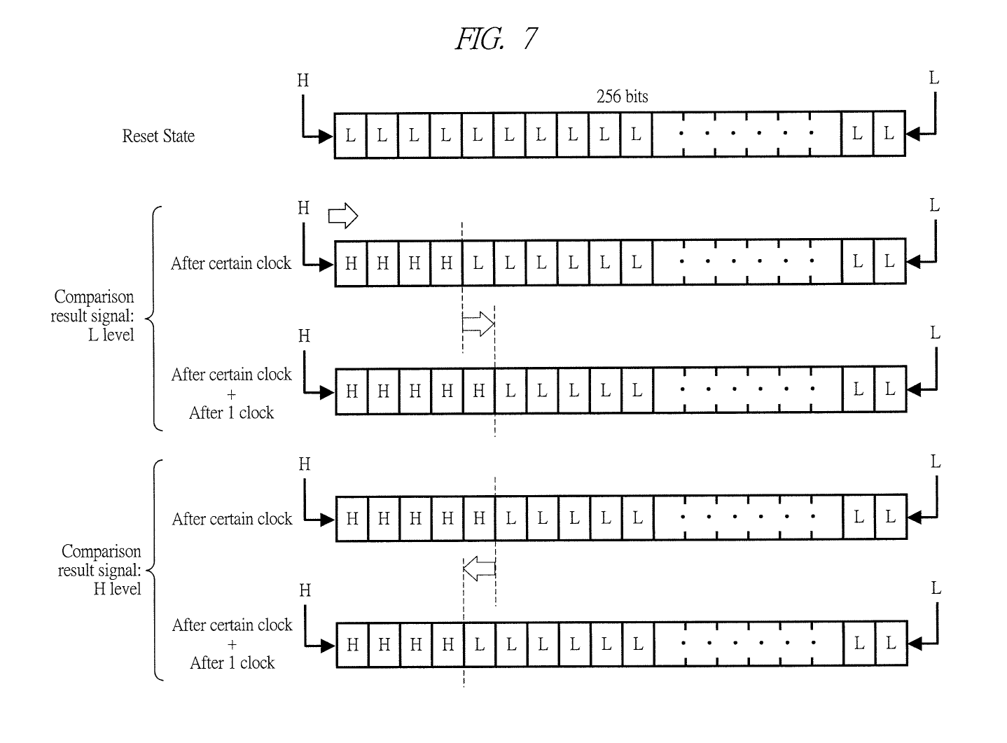

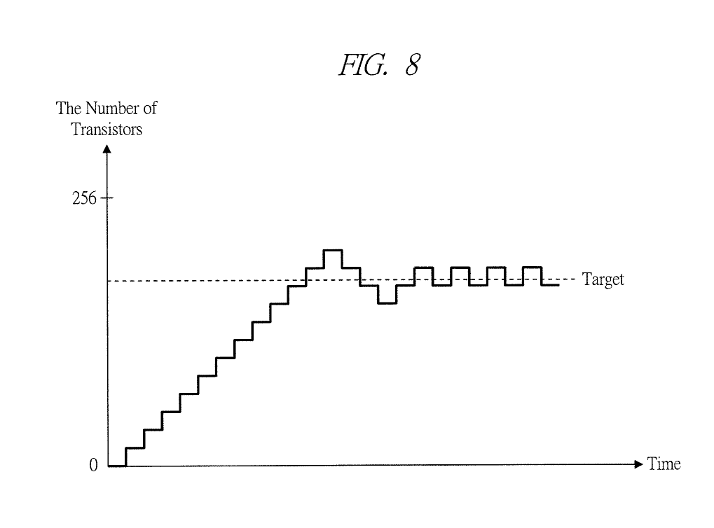

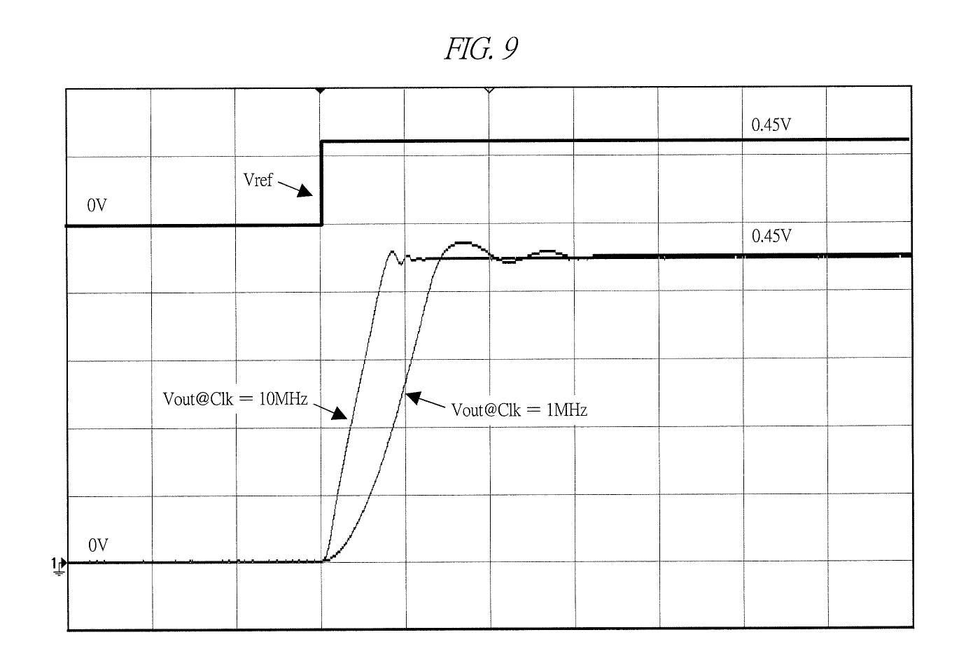

Next, the operation of the shift register 606 is described below with reference to FIGS. 7 to 9. FIG. 7 is a diagram of an example of states and state transitions of the shift register 606. FIG. 8 is a diagram of an example of changes of the number of turn-on PMOS transistors 603 in the switch array 604. FIG. 9 is a diagram of an example of changes of an output voltage outputted to the output terminal 602 with respect to a reference voltage applied to the reference voltage terminal 611.

As illustrated in FIG. 7, a rest state is a state in which an L level is inputted to the reset terminal 612, and a shift operation is not performed even if a clock is inputted to the clock terminal 607. A shift operation is performed when an H level is inputted to the reset terminal 612, and is classified into two operations depending on the inputted comparison result signal 610. When the comparison result signal 610 is at an L level, a shift is made to the right by one bit when the next clock is inputted (after a predetermine clock+one clock), and the leftmost bit is set at an H level. On the other hand, when the comparison result signal 610 is at an H level, a shift is made to left by one bit when the next clock is inputted (after a certain clock+one clock), and the rightmost bit is set at an L level.

The voltage regulator of the present embodiment starts operation when a reset signal inputted to the reset terminal 612 is changed from an L level to an H level. This operation is described below. The comparator 605 compares the feedback voltage 609 and the reference voltage, and then outputs the comparison result signal 610. At this time, if the feedback voltage 609 is equal to or lower than the reference voltage, an L level is outputted as the comparison result signal 610. Conversely, when the feedback voltage 609 is higher than the reference voltage, an H level is outputted as the comparison result signal 610. Then, the shift register 606 performs a shift operation illustrated in FIG. 7 according to the comparison result signal 610 to update the number of turn-on PMOS transistors 603 in the switch array 604 for each clock. Eventually, the voltage outputted to the output terminal 602 is controlled to be the reference voltage inputted to the reference voltage terminal 611.

As for the operation described above, changes of the number of turn-on PMOS transistors 603 in the switch array 604 with respect to time are illustrated in FIG. 8. As illustrated in FIG. 8, the number of turn-on PMOS transistors 603 is changed to reach a target number (Target) corresponding to the reference voltage. In this example, the number of PMOS transistors 603 is initially increased to a state of exceeding the target number, is decreased to be slightly smaller than the target number, and is then ideally converged to the target number.

Also, in the operation described above, changes of the output voltage Vout outputted to the output terminal 602 when the reference voltage Vref changing from 0 V to 0.45 V is inputted to the reference voltage terminal 611 are illustrated in FIG. 9. As illustrated in FIG. 9, the reference voltage Vref changes from 0 V to 0.45 V, the output voltage Vout is abruptly increased to exceed 0.45 V, is decreased to a voltage slightly smaller than 0.45 V, and is then converged to 0.45 V. When the output voltage Vout rises from 0 V to 0.45 V, an abrupt increase occurs with a clock (Clk) of 10 MHz compared with a clock of 1 MHz, and it is converged to 0.45 V quickly.

According to the voltage regulator of the present embodiment described above, in addition to the effects similar to those of the first embodiment, an effect of decreasing power consumption is attained by achieving the switch array 604 with the PMOS transistors 603 and an effect of further decreasing power consumption is attained by using a clocked comparator as the comparator 605.

Note that, in the structure as described in the present embodiment, it is possible to achieve a voltage rising characteristic and a voltage falling characteristic of the output voltage by using two voltage regulators, one configured of NMOS transistors and the other configured of PMOS transistors as switches configuring the switch array 604.

### Fifth Embodiment

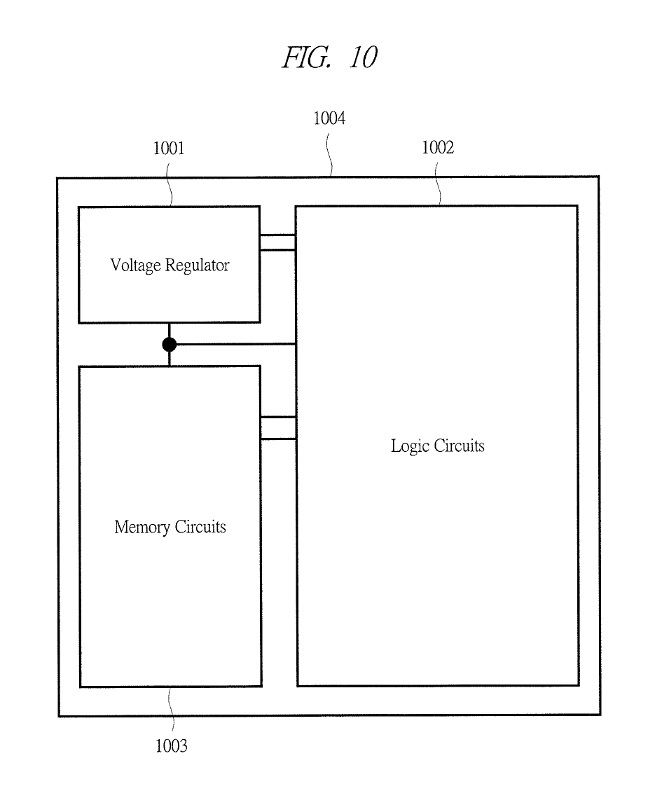

A fifth embodiment of the present invention is described with reference to FIG. 10. The present embodiment represents an example in which the voltage regulator according to any of the first to fourth embodiments is mounted on a semiconductor IC.

FIG. 10 is a diagram of a configuration example of the semiconductor IC having the voltage regulator according to any of the first to fourth embodiments mounted thereon in the fifth embodiment of the present invention.

A semiconductor IC 1004 of the present embodiment includes a voltage regulator 1001 illustrated in any of the first to fourth embodiments, a logic circuit 1002, a memory circuit 1003, and others, and is formed with these circuits integrated on the same semiconductor substrate. The logic circuit 1002 includes, for example, a CPU (Central Processing Unit), an MPU (Micro Processing Unit), and so forth. The memory circuit 1003 includes various memories, such as a RAM, a ROM, a cache, and so forth.

According to the present embodiment described above, even when the voltage regulator 1001, the logic circuit 1002, the memory circuit 1003, and others are integrated together on the semiconductor IC 1004, since the voltage regulator 1001 operates with a digital signal, the voltage regulator 1001 can operate by directly receiving a control signal from the logic circuit 1002 or the like. Thus, it is possible to provide, to the semiconductor IC 1004, the voltage regulator 1001 that is easy to be integrated together with the logic circuit 1002 and the memory circuit 1003 and others.

### Sixth Embodiment

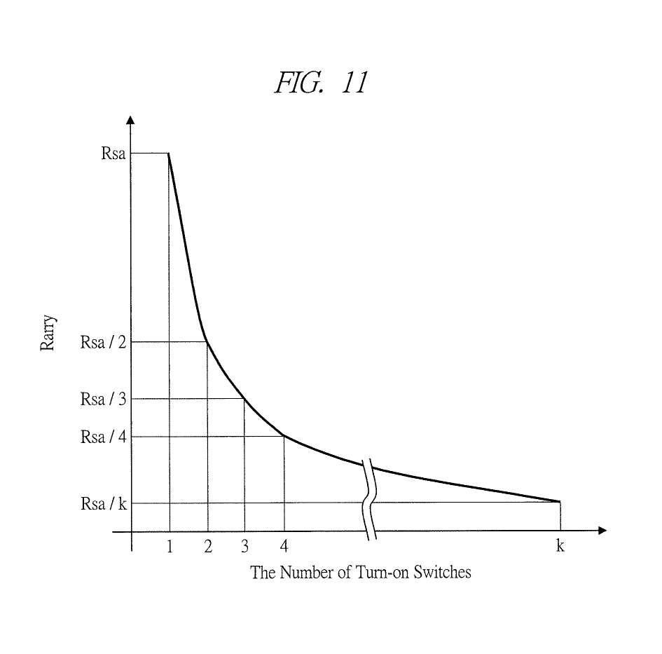

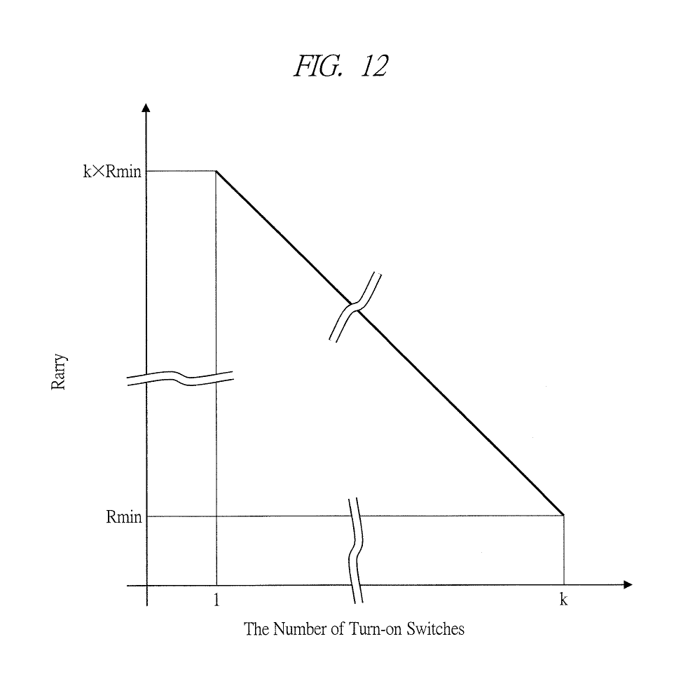

A sixth embodiment of the present invention is described with reference to FIGS. 11 and 12. In the present embodiment, a relation between resistance of the entire switch array and the number of turn-on switches in the voltage regulator according to any of the first to fourth embodiments.

FIG. 11 is a diagram of an example of a relation between resistance on the entire switch array 104 and the number of turn-on switches 103 with the voltage regulator according to any of the first to third embodiments as an example. In FIG. 11, an ON resistance of the switch 103 is Rsa, the resistance of the entire switch array 104 is Rarry, and the number of turn-on switches 103 is 1 to k.

As illustrated in FIG. 11, the resistance Rarry of the entire switch array 104 has a monotonous decrease relation with respect to the number of turn-on switches 103 (represented by a curve in which: the resistance is Rsa when the number is 1, the resistance is abruptly decreased to Rsa/2 when the number is 2, the resistance is decreased to Rsa/3 when the number is 3 more mildly than when the number is 2, the resistance is decreased to Rsa/4 when the number is 4 more mildly than the case when the number is 3, . . . the resistance is decreased to Rsa/k when the number is k). Based on this relation, the output voltage control is achieved in the voltage regulator according to any of the first to third embodiments.

FIG. 12 is a diagram of an example of a relation between a resistance on the entire switch array 604 using PMOS transistors 603 as weighted switches and the number of turn-on PMOS transistors 603 in the voltage regulator according to the fourth embodiment as an example. When the switch array is configured of switches for which the order of turning ON or OFF is determined, such as each PMOS transistor 603 in the switch array 604, the ON resistance of each PMOS transistor 603 is weighted with a relation represented by Equation (4):

SW−Propᵢ=(k−i+1)×(k−i+2) (4).

Note that, in Equation (4), SW-Propᵢ is a ratio of i-th turn-on switches and k is a total number of switches.

As such, by weighting the ON resistance of each PMOS transistor 603 with the relation represented by Equation (4), when the resistance value of the switch array 604 with all of the PMOS transistors 603 being turned on is Rmin, the number of turn-on PMOS transistors 603 and the resistance Rarry of the switch array 604 have a linear relation as illustrated in FIG. 12 (while the resistance is k×Rmin when the number is 1, . . . , the resistance is Rmin when the number is k, the relation is represented by a decreasing straight line connecting the resistance k×Rmin when the number is 1 and the resistance Rmin when the number is k), thereby improving controllability.

The voltage regulator according to the fourth embodiment uses the switch array 604 configured of the PMOS transistors 603 as weighted switches as illustrated in FIG. 12. In the voltage regulator according to the fourth embodiment, output voltage control is achieved based on the relation as described above.

According to the present embodiment described above, with the switch array 604 using the PMOS transistors 603 as weighted switches, linearity between the number of turn-on switches and the output voltage is improved, and therefore controllability can be improved.

### Seventh Embodiment

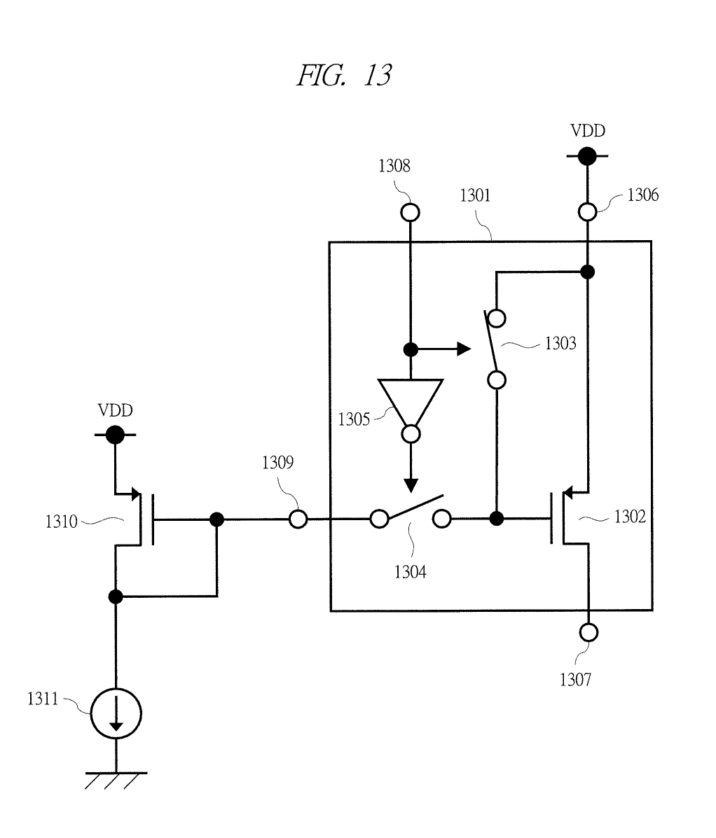

A seventh embodiment of the present invention is described with reference to FIG. 13. The present embodiment represents a second configuration example of the switch 103 for use in the switch array 104 of the voltage regulator according to the first embodiment (and also the second and third embodiments). A switch circuit of the second configuration example is configured so that, according to a switch control signal controlling the gate of a MOSFET (PMOS transistor 1302), a coupling between a voltage with which the MOSFET is turned off and a voltage with which the MOSFET has a certain current characteristic is switched.

FIG. 13 is a diagram of a second configuration example of the switch 103 for use in the switch array 104 in the voltage regulator according to the seventh embodiment of the present invention.

As illustrated in FIG. 13, in the second configuration example of the switch 103, a switch circuit 1301 includes a switch input terminal 1306, a switch output terminal 1307, a switch control terminal 1308, and a bias terminal 1309; a PMOS transistor 1302 connecting the switch control terminal 1306 and the source and the switch output terminal 1307 and the drain; a switch 1303 connecting the gate of the PMOS transistor 1302 to the switch input terminal 1306; a switch 1304 connected to a bias terminal 1309; and an inverter 1305 inverting a signal of the switch control terminal 1308.

For example, in the relation with the voltage regulator illustrated in FIG. 1, the switch circuit 1301 is configured so that the switch input terminal 1306 is connected to the input terminal 101, the switch output terminal 1307 is connected to the output terminal 102, and the switch control terminal 1308 is connected to the controller 109.

In the switch circuit 1301, when an H level is inputted to the switch control terminal 1308, the switch 1303 is short-circuited, the switch 1304 is shifted to an open state, and the PMOS transistor 1302 is turned off. On the other hand, when an L level is inputted to the switch control terminal 1308, the switch 1303 becomes open, the switch 1304 is in a short-circuited state, and the gate of the PMOS transistor 1302 has a voltage to be inputted to the bias terminal 1309.

To the bias terminal 1309, the gate of the PMOS transistor 1310 in a diode connection biased by a current source 1311 is connected. For this reason, when an L level is inputted to the switch control terminal 1308, the PMOS transistor 1302 and the PMOS transistor 1310 form a current mirror circuit. Therefore, the switch circuit 1301 has a function equivalent to a current source. A voltage regulator using a switch array configured of the switch circuit 1301 is described in the seventh embodiment of the present invention.

According to the present embodiment described above, as with the switch array configured of the weighted switches in the sixth embodiment, linearity between the number of turn-on switches and the output voltage is improved, and therefore controllability can be improved.

### Eighth Embodiment

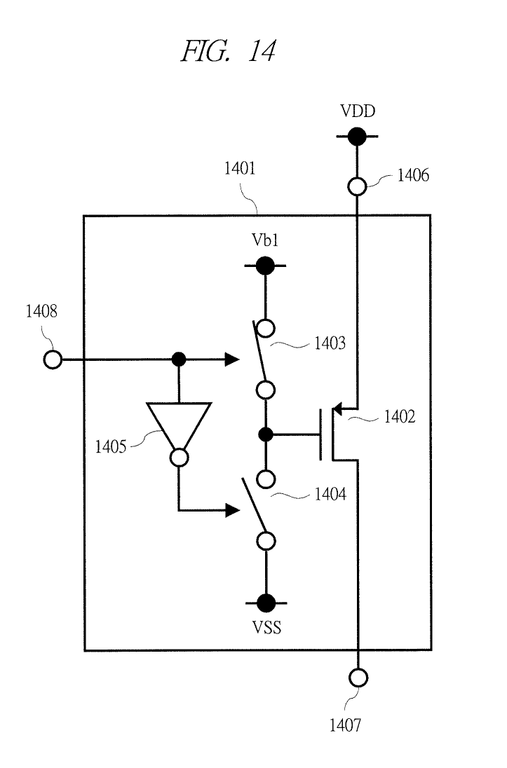

An eighth embodiment of the present invention is described with reference to FIG. 14. The present embodiment represents a third configuration example of the switch 103 for use in the switch array 104 in place of the second configuration example described in the seventh embodiment.

FIG. 14 is a diagram of a third configuration example of the switch 103 for use in the switch array 104 in the voltage regulator according to the eighth embodiment of the present invention.

As illustrated in FIG. 14, in the third configuration example of the switch 103, a switch circuit 1401 includes a switch input terminal 1406, a switch output terminal 1407, and a switch control terminal 1408; a PMOS transistor 1402 connecting the switch input terminal 1406 and the source and the switch output terminal 1407 and the drain; a switch 1403 connecting the gate of the PMOS transistor 1402 to a voltage Vb1 higher than VDD; a switch 1404 connecting the gate of the PMOS transistor 1402 to VSS; and an inverter 1405 inverting a signal of the switch control terminal 1408.

For example, in the relation with the voltage regulator illustrated in FIG. 1, the switch circuit 1401 is configured so that the switch input terminal 1406 is connected to the input terminal 101, the switch output terminal 1407 is connected to the output terminal 102, and the switch control terminal 1408 is connected to the controller 109.

In the switch circuit 1401, when an H level is inputted to the switch control terminal 1408, the switch 1403 is short-circuited, the switch 1404 becomes open, and the PMOS transistor 1402 is turned off. On the other hand, when an L level is inputted to the switch control terminal 1408, the switch 1403 becomes open, the switch 1404 is short-circuited, and the PMOS transistor 1402 is turned on. As such, the switch 1403 and the switch 1404 are exclusively controlled with a signal inputted to the switch control terminal 1408. A voltage regulator using a switch array configured of the switch circuit 1401 is described in the eighth embodiment of the present invention.

According to the present embodiment described above, when the PMOS transistor 1402 is turned off, that is, when an H level is inputted to the switch control terminal 1408, the gate of the PMOS transistor 1402 is biased to the voltage Vb1 higher than VDD, and therefore is turned off more deeply, thereby achieving an effect of decreasing a leak current in an OFF state.

### Ninth Embodiment

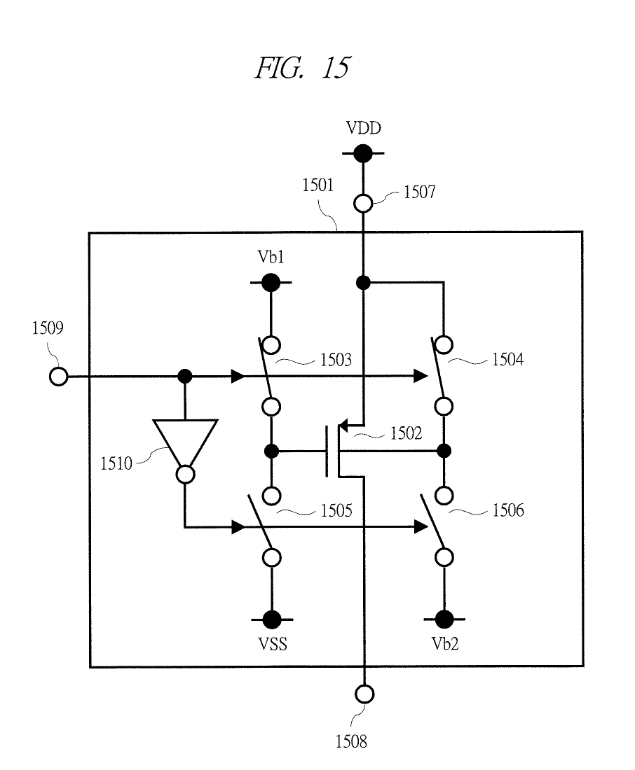

A ninth embodiment of the present invention is described with reference to FIG. 15. The present embodiment depicts a fourth configuration example of the switch 103 for use in the switch array 104 in place of the third configuration example described in the eighth embodiment. A switch circuit of this fourth configuration example is configured so that a voltage with which the MOSFET is turned off and a voltage with which the MOSFET is turned on are switched according to a switch control signal for controlling the gate of the MOSFET (PMOS transistor 1502) and the substrate of the MOSFET is connected for a forward bias voltage when the MOSFET is turned on and the substrate of the MOSFET is connected to the source when the MOSFET is turned off.

FIG. 15 depicts a fourth configuration example of the switch 103 for use in the switch array 104 in a voltage regulator according to the ninth embodiment of the present invention.

As illustrated in FIG. 15, the fourth configuration example of the switch 103 includes a switch input terminal 1507, a switch output terminal 1508, and a switch control terminal 1509; a PMOS transistor 1502 connecting the switch input terminal 1507 and the source together and the switch output terminal 1508 and the drain; a switch 1503 connecting the gate of the PMOS transistor 1502 for a voltage Vb1 higher than VDD; a switch 1504 connecting the substrate of the PMOS transistor 1502 and the switch input terminal 1507; a switch 1505 connecting the gate of the PMOS transistor 1502 to VSS; a switch 1506 connecting the substrate of the PMOS transistor 1502 to a substrate bias voltage Vb2; and an inverter 1510 inverting a signal from the switch control terminal 1509.

This switch circuit 1501 is configured, for example, in a relation with the voltage regulator illustrated in FIG. 1, so that the switch input terminal 1507 is connected to the input terminal 101, the switch output terminal 1508 is connected to the output terminal 102, and the switch control terminal 1509 is connected to the controller 109.

In this switch circuit 1501, the switches 1503 and 1504 and the switches 1505 and 1506 are exclusively controlled with a switch control signal. When an H level is inputted to a switch control signal, the switches 1503 and 1504 are short-circuited, the gate of the PMOS transistor 1502 is connected to the voltage Vb1 higher than VDD, to cause the substrate is connected to the source, and to cause the PMOS transistor 1502 becomes in a strong OFF state. Here, the switches 1505 and 1506 are in an open state, and the PMOS transistor 1502 is turned off.

On the other hand, when an L level is inputted to the switch control terminal, the switches 1503 and 1504 becomes in an open state, the switches 1505 and 1506 are short-circuited, the gate of the PMOS transistor 1502 is connected to VSS, and the substrate is connected to a forward bias Vb2. In this manner, the PMOS transistor 1502 is turned on more strongly, and the ON resistance of the PMOS transistor 1502 becomes smaller than normal due to a substrate bias effect. The ninth embodiment represents the voltage regulator of the present invention using a switch array configured of the switch circuit 1501 as described above.

According to the embodiments described above, the switch array using the switch circuit 1501 has a resistance value smaller than that when all switches are turned on, and therefore the embodiments are effective when a voltage drop in the switch array is desired to be as small as possible.

In the foregoing, the invention made by the inventor of the present invention has been concretely described based on the embodiments. However, it is needless to say that the present invention is not limited to the foregoing embodiments and various modifications and alterations can be made within the scope of the present invention.

The voltage regulator of the present invention can be used as a voltage regulator converting an input voltage to a desired output voltage based on a reference voltage.

What is claimed is:

1. A voltage regulator comprising:
a switch array in which a plurality of switches are connected in parallel;
a switch state register storing an ON or OFF state of each of the switches in the switch array; and
a comparator comparing a reference voltage and a voltage of an output terminal coupled to an output of the switch array and outputting a result of the comparison as a digital value, wherein
a state of each of the switches in the switch array is changed by updating a value of the switch state register in accordance with an output of the digital value from the comparator.

2. The voltage regulator according to claim 1, further comprising:
a change value register storing an amount of change of a value to be updated in the switch state register; and
a history storage register storing a change history of the switch state register, wherein
a value of the change value register is updated in accordance with a state of the change history in the switch state register, and, according to the output of the digital value from the comparator, the switch state register is updated so that a value of the switch state register is increased or decreased only by the value of the change value register.

3. The voltage regulator according to claim 1, wherein
a shift register shifting a value of a register according to an output from the comparator for each clock is used as the switch state register.

4. The voltage regulator according to claim 1, wherein
the voltage regulator is integrated together with a logic circuit and a memory circuit on a same semiconductor IC.

5. The voltage regulator according to claim 1, wherein
a switch circuit including a MOSFET is used as each of the switches of the switch array, and
the switch circuit is configured to switch between a connection to a voltage at which the MOSFET is turned off and a connection to a voltage at which the MOSFET has a predetermined current characteristic, according to a switch control signal controlling a gate of the MOSFET.

6. The voltage regulator according to claim 1, wherein
a switch circuit including a MOSFET is used as each of the switches of the switch array, and
the switch circuit is configured to switch between a connection to a voltage at which the MOSFET is turned off and a connection to a voltage at which the MOSFET is turned on, according to a switch control signal controlling a gate of the MOSFET; and the switch circuit is configured to connect a substrate of the MOSFET to a forward bias voltage when the MOSFET is turned on and connect the substrate of the MOSFET to a source when the MOSFET is turned off.

7. A voltage regulator comprising:
a switch array in which a plurality of switches are connected in parallel;
a switch state register storing an ON or OFF state of each of the switches in the switch array; and
an inverter having a logical threshold corresponding to a desired output voltage, comparing the logical threshold with a voltage of an output terminal connected to an output of the switch array, and outputting a result of the comparison as a digital value, wherein
a state of each of the switches in the switch array is changed by updating a value of the switch state register in accordance with an output of the digital value from the inverter.

8. The voltage regulator according to claim 7, further comprising:
a change value register storing an amount of change of a value to be updated in the switch state register; and
a history storage register storing a change history of the switch state register, wherein
a value of the change value register is updated in accordance with a state of the change history in the switch state register, and, according to the output of the digital value from the inverter, the switch state register is updated so that a value of the switch state register is increased or decreased only by the value of the change value register.

9. The voltage regulator according to claim 7, wherein
a shift register shifting a value of a register according to an output from the inverter for each clock is used as the switch state register.

10. The voltage regulator according to claim 7, wherein
the voltage regulator is integrated together with a logic circuit and a memory circuit on a same semiconductor IC.

11. The voltage regulator according to claim 7, wherein
a switch circuit including a MOSFET is used as each of the switches of the switch array, and
the switch circuit is configured to switch between a connection to a voltage at which the MOSFET is turned off and a connection to a voltage at which the MOSFET has a predetermined current characteristic, according to a switch control signal controlling a gate of the MOSFET.

12. The voltage regulator according to claim 7, wherein
a switch circuit including a MOSFET is used as each of the switches of the switch array, and
the switch circuit is configured to switch between a connection to a voltage at which the MOSFET is turned off and a connection to a voltage at which the MOSFET is turned on, according to a switch control signal controlling a gate of the MOSFET; and the switch circuit is configured to connect a substrate of the MOSFET to a forward bias voltage when the MOSFET is turned on and connect the substrate of the MOSFET to a source when the MOSFET is turned off.

13. A voltage regulator comprising:
a switch array in which a plurality of switches are connected in parallel;
a switch state register storing an ON or OFF state of each of the switches in the switch array;
a change value register storing a value to be added or subtracted at the time of updating the switch state register; and
a plurality of comparators comparing reference voltages having different voltages and a voltage of an output terminal connected to an output of the switch array and outputting each result of the comparison as a digital value, wherein
a state of each of the switches in the switch array is changed by updating a value of the change value register in accordance with an output of a digital value from a first comparator among the plurality of comparators and updating a value of the switch state register in accordance with an output of a digital value from a second comparator that is different from the first comparator.

14. The voltage regulator according to claim 13, further comprising:
a history storage register storing a change history of the switch state register, wherein
a value of the change value register is updated in accordance with a state of the change history in the switch state register, and, according to the output of the digital value from the second comparator, the switch state register is updated so that a value of the switch state register is increased or decreased only by the value of the change value register.

15. The voltage regulator according to claim 13, wherein
a shift register shifting a value of a register according to an output from the second comparator for each clock is used as the switch state register.

16. The voltage regulator according to claim 13, wherein
the voltage regulator is integrated together with a logic circuit and a memory circuit on a same semiconductor IC.

17. The voltage regulator according to claim 13, wherein
a switch circuit including a MOSFET is used as each of the switches of the switch array, and
the switch circuit is configured to switch between a connection to a voltage at which the MOSFET is turned off and a connection to a voltage at which the MOSFET has a predetermined current characteristic, according to a switch control signal controlling a gate of the MOSFET.

18. The voltage regulator according to claim 13, wherein
a switch circuit including a MOSFET is used as each of the switches of the switch array, and
the switch circuit is configured to switch between a connection to a voltage at which the MOSFET is turned off and a connection to a voltage at which the MOSFET is turned on, according to a switch control signal controlling a gate of the MOSFET; and the switch circuit is configured to connect a substrate of the MOSFET to a forward bias voltage when the MOSFET is turned on and connect the substrate of the MOSFET to a source when the MOSFET is turned off.
